(19) United States
(12) Patent Application Publication
(10) Pub. No.: US 2026/0236395 A1
(43) Pub. Date: Aug. 13, 2026

(54) MEMORY SYSTEMS, MEMORY CONTROLLERS, OPERATION METHODS, STORAGE MEDIA, AND PRODUCTS

(71) Applicant: Yangtze Memory Technologies Co., Ltd., Wuhan (CN)

(72) Inventors: Weilin Liu, Wuhan (CN); Zhe Sun, Wuhan (CN)

(21) Appl. No.: 19/236,641

(22) Filed: Jun. 12, 2025

(30) Foreign Application Priority Data
Feb. 7, 2025 (CN) 202510138573.9

(51) Int. Cl. G06F 12/02; G06F 11/10; G06F 13/16

(52) U.S. Cl. CPC G06F 12/0292; G06F 11/1004; G06F 13/1615; G06F 13/1673

(57) ABSTRACT

Examples of the present disclosure provide a memory system, a memory controller, an operation method, a computer-readable storage medium, and a computer program product. The method includes: receiving an operation command from a host; receiving a logical address translation request sent by a controller processor in response to the operation command, wherein the logical address translation request includes a logical address; retrieving a physical address corresponding to the logical address from a logical address to physical address mapping table, wherein the logical address to physical address mapping table is obtained by a host interface controller from a memory of the host, and the memory of the host stores the logical address to physical address mapping table therein; sending the physical address to the controller processor. The method reduces migration of the logical address to physical address mapping table between memories of a memory system, improves performance, and reduces energy consumption.

### CROSS-REFERENCE TO RELATED APPLICATION

This application claims priority to and the benefit of Chinese Patent Application 202510138573.9, filed on Feb. 7, 2025, which is hereby incorporated by reference in its entirety.

### TECHNICAL FIELD

The present disclosure relates to the field of semiconductor technology, and in particular, to memory systems, memory controllers, operation methods, computer-readable storage media, and computer program products.

### BACKGROUND

In some memory systems including a non-volatile memory (e.g., a flash memory), such as an SSD (Solid State Disk), data may be stored in a memory of a host as needed, for example, in a DRAM (Dynamic Random Access Memory) provided in the host. The host memory buffer (HMB) is a function supported by the NVMEI (Non-Volatile Memory Express Interface), that is, a part of storage space in the memory of the host is allocated for the memory system to use, for example, if the buffer memory in the memory system is not enough, the memory system can access the HMB of the host. During operation of the memory system, a logical address to physical address mapping (L2P) table may be stored in the host memory.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure. Apparently, the accompanying drawings in the following description show merely some examples of the present disclosure, and persons of ordinary skill in the art may still derive other accompanying drawings from these accompanying drawings without creative efforts.

FIG. 1 shows a block diagram of an example system with a memory in an example of the present disclosure.

FIG. 2 shows a block diagram of a memory system.

FIG. 3 shows a block diagram of another memory system.

FIG. 4 shows a schematic diagram of a memory system with a memory controller having a cache according to an example of the present disclosure.

FIG. 5 shows a flowchart of an operation method of a memory system according to an example of the present disclosure.

FIG. 6 shows a flowchart of an operation method of a memory system according to another example of the present disclosure.

FIG. 7 shows a flowchart of an operation method of a memory system according to yet another example of the present disclosure.

FIG. 8 shows a flowchart of an operation method of a memory system according to yet another example of the present disclosure.

FIG. 9 shows a flowchart of obtaining a physical address corresponding to a logical address according to an example of the present disclosure.

FIG. 10 shows a flowchart of an operation method of a memory system according to yet another example of the present disclosure.

FIG. 11 shows a block diagram of an example system including a memory system according to an example of the present disclosure.

### DETAILED DESCRIPTION

Examples will now be described more fully with reference to the accompanying drawings. However, the examples may be implemented in various forms and should not be construed as being limited to the examples set forth herein; rather, these examples are provided so that this disclosure will be thorough and complete, and will fully convey the concept of the examples to those skilled in the art. The same reference numerals in the drawings denote the same or similar parts, and thus repeated description thereof will be omitted.

The features, structures, or characteristics described in the present disclosure may be combined in one or more examples in any suitable manner. In the following description, many specific details are provided to give a full understanding of the examples of the present disclosure. However, those skilled in the art will appreciate that the technical solutions of the present disclosure may be practiced without one or more of the specific details, or other methods, components, devices, steps, etc. may be employed. In other cases, well-known methods, devices, implementations, or operations are not shown or described in detail to avoid obscuring aspects of the present disclosure.

The accompanying drawings are merely schematic illustrations of the present disclosure, and the same reference numerals in the drawings denote the same or similar parts, and thus repeated description thereof will be omitted. Some of the block diagrams shown in the accompanying drawings do not necessarily correspond to physically or logically independent entities. These functional entities may be implemented in the form of software, or implemented in at least one hardware module or integrated circuit, or implemented in at least one of different networks, processor devices or microcontroller devices.

The flowcharts shown in the accompanying drawings are merely example descriptions, and do not necessarily include all content and steps, and are not necessarily performed in the described order. For example, some steps may also be decomposed, and some steps may be combined or partially combined, so the actual execution order may be changed according to actual situations.

In this specification, the terms “one”, “a”, “the”, “said” and “at least one” are configured to indicate the presence of at least one element/component/etc.; the terms “include”, “comprise” and “have” are configured to indicate an open inclusive meaning and refer to that there may be other elements/components/etc., in addition to the listed elements/components/etc.; the terms “first”, “second” and “third” are only used as labels, and are not intended to limit the number of objects thereof.

Terms used in the present disclosure are described below.

A logical address to physical address (L2P) table is referred to as a logical address to physical address mapping table (herein referred to as a logical-physical mapping table), and is configured to store a correspondence between a logical address and a physical address.

A HMB (host memory buffer) is referred to as a host memory buffer, provides a storage resource of a host to a memory system (such as an SSD) as a mechanism. In this mechanism, the memory system uses a memory of the host as a cache of the memory system.

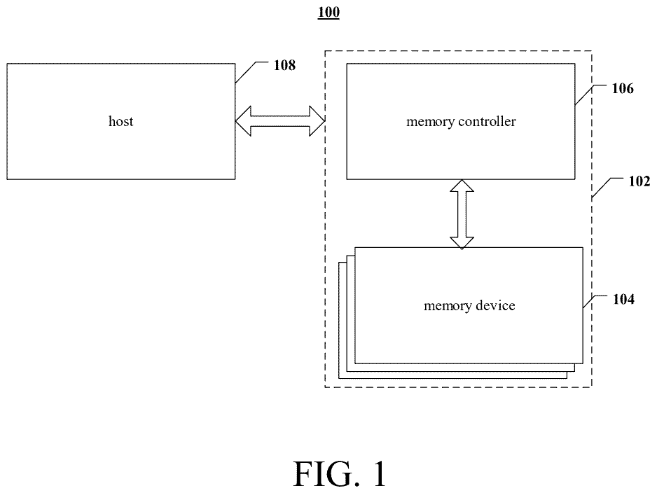

FIG. 1 shows a block diagram of an example system with a memory according to an example of the present disclosure. The system 100 may be a mobile phone, a desktop computer, a laptop computer, a tablet computer, a vehicle computer, a gaming console, a printer, a positioning device, a wearable electronic device, a smart sensor, a virtual reality (VR) device, an augmented reality (AR) device, or any other suitable electronic device having storage therein. As shown in FIG. 1, system 100 may include a host 108 and a memory system 102 having one or more memory devices 104 and a memory controller 106.

The host 108 may be a processor (e.g., a central processing unit (CPU)) or a system on chip (SoC) (e.g., an application processor (AP)) of an electronic device. The host 108 may be coupled to the memory controller 106 and configured to send data to the memory device 104 or receive data from the memory device 104 through the memory controller 106. For example, the host 108 may send program data in a program operation or receive read data in a read operation. The host 108 is configured to receive instructions and commands from the memory controller 106 of the memory system 102, and send instructions and commands to the memory controller 106 of the memory system 102, and to perform or implement multiple functions and operations provided in the present disclosure, which will be described below.

The memory device 104 may be any of the memory devices disclosed in the present disclosure, such as a NAND flash memory device that includes a page buffer having multiple portions. Note that NAND flash memory is only an example of a memory device for illustrative purposes. The memory device 104 may include any suitable non-volatile memory, such as NOR flash memory, Ferroelectric Random Access Memory (FeRAM), Phase Change Memory (PCM), Magnetic Random Access Memory (MRAM), Spin Transfer Torque Random Access Memory (STT-RAM), or Resistive Random Access Memory (RRAM), among others. In some implementations, the memory device 104 includes three-dimensional (3D) NAND flash memory.

The memory controller 106 may be implemented by at least one of a microprocessor, a microcontroller (also referred to as a microcontroller unit (MCU)), a digital signal processor (DSP), an application specific integrated circuit (ASIC), a field-programmable gate array (FPGA), a programmable logic device (PLD), a state machine, gated logic, a discrete hardware circuit, and other suitable hardware, firmware, or software configured to perform the various functionality described in detail below.

According to some implementations, the memory controller 106 is coupled to the memory device 104 and the host 108, and is configured to control the memory device 104. Memory controller 106 can manage data stored in memory device 104 and communicate with host 108. In some implementations, the memory controller 106 is designed to operate in low duty cycle environments, such as secure digital (SD) cards, compact flash (CF) cards, universal serial bus (USB) flash drives, or other media for use in electronic devices (e.g., personal computers, digital cameras, mobile telephones, etc.). In some implementations, the memory controller 106 is designed for operating SSDs in high duty cycle environments or as an embedded MultiMedia Card (eMMC) for data storage and enterprise storage arrays for mobile devices (e.g., smartphones, tablet computers, laptop computers, etc.). The memory controller 106 may be configured to control operations, e.g., read, erase, and program operations, of the memory device 104 by providing instructions, such as read instructions, to memory device 104. For example, memory controller 106 may be configured to provide read instructions to peripheral circuits of memory device 104 to control read operations. The memory controller 106 may also be configured to manage various functions with respect to data stored or to be stored in the memory device 104, including but not limited to bad block management, garbage collection (GC), logical address to physical address address translation, wear leveling, etc. In some implementations, the memory controller 106 is further configured to process an error correcting code (ECC) with respect to data read from the memory device 104 or written to the memory device 104. The memory controller 106 may also perform any other suitable functions, such as formatting the memory device 104.

The memory controller 106 may communicate with an external device (e.g., the host 108) according to a particular communication protocol. For example, the memory controller 106 may communicate with the external device through at least one of various interface protocols, such as a USB protocol, a Multi Media Card (MMC) protocol, a Peripheral Component Interconnect (PCI) protocol, a Peripheral Component Interconnect Express (PCI-E) protocol, an Advanced Technology Attachment (ATA) protocol, a Serial ATA protocol, a Parallel ATA protocol, a Small Computer System Interface (SCSI) protocol, an Enhanced Small Drive Interface (ESDI) protocol, an Integrated Drive Electronics (IDE) protocol, and a Firewire protocol and the like.

The memory controller 106 and one or more memory devices 104 may be integrated into various types of storage devices, for example, included in the same package (e.g., a Universal Flash Storage (UFS) package or an eMMC package). That is, the memory system 102 may be implemented and packaged into different types of end electronics.

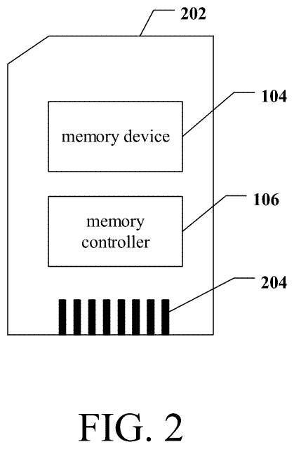

In an example as shown in FIG. 2, the memory controller 106 and the memory device 104 may be integrated into a memory card 202. The memory card 202 may include a PC card (PCMCIA (Personal Computer Memory Card International Association) card), a CF card, a smart media (SM) card, a memory stick, a multimedia card (MMC), an SD card, a UFS, etc. The memory card 202 may also include a memory card connector 204 that couples the memory card with a host (e.g., host 108 in FIG. 1).

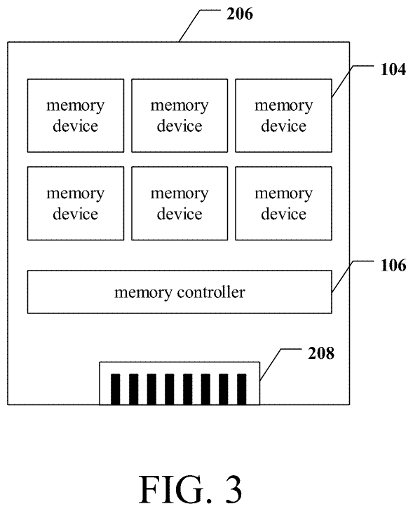

In another example as shown in FIG. 3, the memory controller 106 and the plurality of memory devices 104 may be integrated into the solid state drive 206. The solid state drive 206 may also include a solid state drive connector 208 that couples the solid state drive 206 with a host (e.g., the host 108 in FIG. 1). In some implementations, at least one of the storage capacity or operation speed of the solid state drive 206 is greater than at least one of the storage capacity or operation speed of the memory card 202.

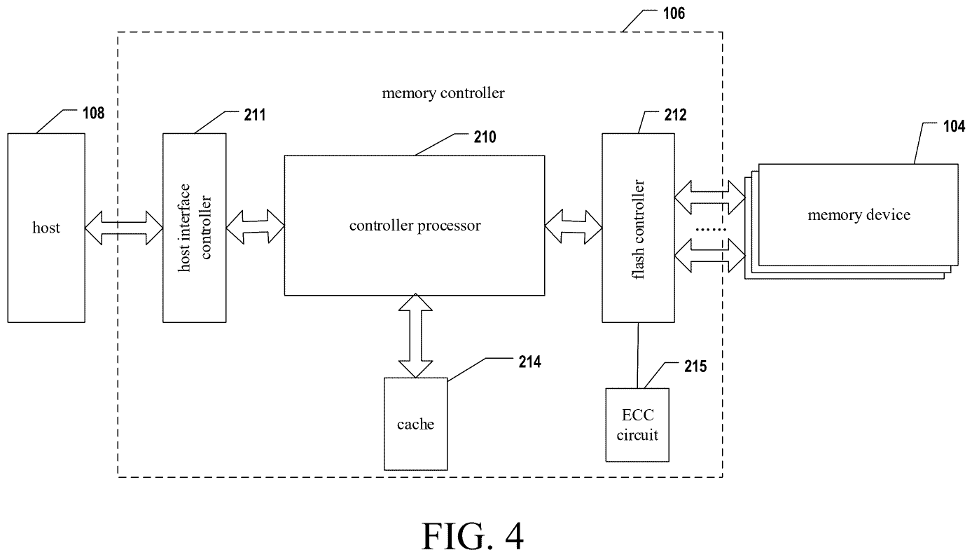

FIG. 4 shows a schematic diagram of an example memory system with a memory controller having a cache according to an example of the disclosure. As shown in FIG. 4, the memory controller 106 is respectively coupled to the host 108 and one or more memory devices 104, and is configured to control the host 108 to send data to the memory device 104 or read data from the memory device 104 back to the host 108. The memory controller 106 includes at least a controller processor 210, a host interface controller 211, a flash controller 212, a cache 214, and an error correction code (ECC) circuit 215.

The controller processor 210 may be configured to execute control logic and an algorithm of the memory controller, including but not limited to functions such as address mapping, garbage collection, and wear leveling. The controller processor 210 may be implemented by an embedded processor or an FPGA.

The host interface controller 211 is respectively coupled to the host 108 and the controller processor 210. The host interface controller 211 may be a communication interface component between the host and the memory controller responsible for data transmission between the host and the memory controller, including data reading and writing, and command receiving and sending. It may support various interfaces (such as Serial Advanced Technology Attachment (SATA) and PCIe) and protocols (such as Advanced Host Controller Interface (AHCI) and Non-Volatile Memory Express (NVMe)), and provide data transmission functions.

The flash controller 212 is respectively coupled to the memory device 104 and the controller processor 210, and may be a communication interface component between the memory device and the memory controller.

The cache 214 is coupled to the controller processor 210, and may include a component configured to temporarily store data. The cache 214 may be further configured to cache instructions and data. It may include high-speed memory devices such as DRAM (Dynamic Random-Access Memory) and SRAM (Static Random-Access Memory).

The ECC circuit 215 is used for error detection and correction for data read from the memory device. ECC check data may be stored in a reserved space of the memory device 104 for check of the data.

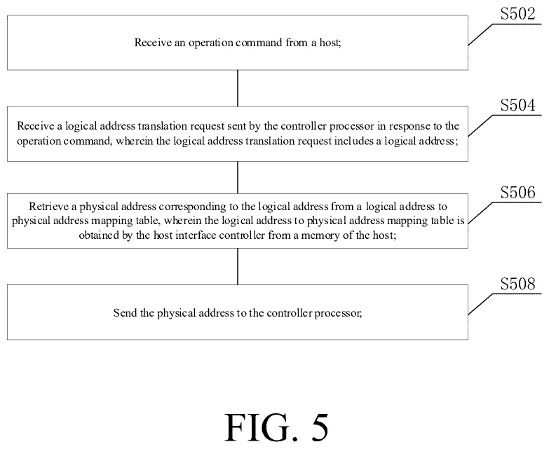

FIG. 5 shows a flowchart of an operation method of a memory system according to an example of the present disclosure. This example is applied to a host interface controller of a memory controller.

As shown in FIG. 5, at S502, an operation command from a host is received. The operation command of the host may include a read operation command, an erase command, and the like. In some examples, the host interface controller receives an operation command from the host, and places the parsed operation command into a command queue of the memory controller. After the operation command is parsed, key information such as an operation code (to determine that it is a read operation), a logical address, and a data length is obtained.

At S504: A logical address translation request sent by a controller processor in response to an operation command is received, wherein the logical address translation request includes a logical address. The controller processor obtains the stored logical address from the command queue and sends a logical address translation request to the host interface controller.

At S506: A physical address (PAA) corresponding to the logical address is retrieved from a logical address to physical address mapping table, wherein the logical address to physical address mapping table is obtained by a host interface controller from a memory of a host.

At S508: The physical address is sent to the controller processor for the controller processor to execute an operation command according to the obtained physical address.

In the foregoing example, when the memory controller processes the operation command from the host, the logical address to physical address mapping table obtained by the host interface controller from the host memory is stored in a cache of the host interface controller, rather than being stored in the SRAM of the memory controller and reading the SRAM for the physical address corresponding to the logical address. Instead, the host interface controller directly retrieves the physical address corresponding to the logical address in the cache of the host interface controller based on the logical address translation request sent by the controller processor, thereby reducing migration of the logical address to physical address mapping table in the memory system, improving the performance, and reducing energy consumption. Moreover, the host interface controller performs address translation, which reduces a computing load of the FW (firmware), especially when performing random read (RR), the computing power of the FW is a computing bottleneck.

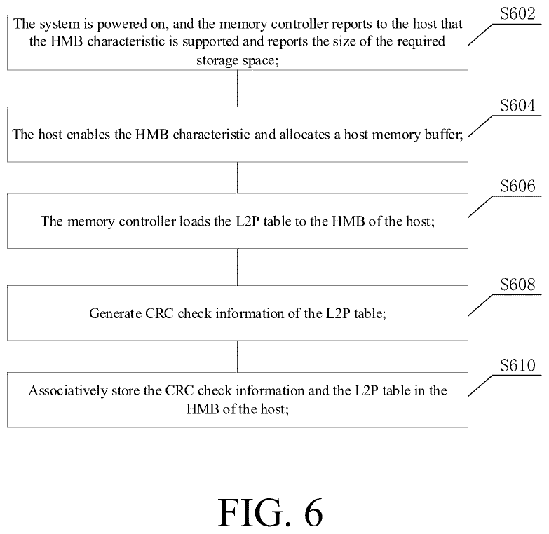

FIG. 6 shows a flowchart of an operation method of a memory system according to another example of the present disclosure.

As shown in FIG. 6, at S602, the system is powered on, and the memory controller reports to the host that the HMB characteristic is supported and reports the size of the required storage space. The HMB is a characteristic supported by the NVMe protocol, and it may be reported to the host that the memory system supports the characteristic.

At S604, the host enables the HMB characteristic and allocates a host memory buffer. In an example, the host allocates a space in the memory, such as a DRAM, for use by the memory system.

At S606, the memory controller reads the L2P table from the memory device, and loads the L2P table to the HMB of the host.

At S608, the memory controller generates cyclic redundancy check (CRC) check information of the L2P table.

At S610, the memory controller associatively stores the CRC check information and the L2P table in the HMB of the host.

In the foregoing example, after the system is powered on, the memory control system reports to the host that the HMB characteristic is supported and reports the required storage space, so that: the host can start and allocate the HMB according to a requirement; and CRC check information of the L2P table is generated and stored in association with the L2P table, thereby enhancing operation security and integrity.

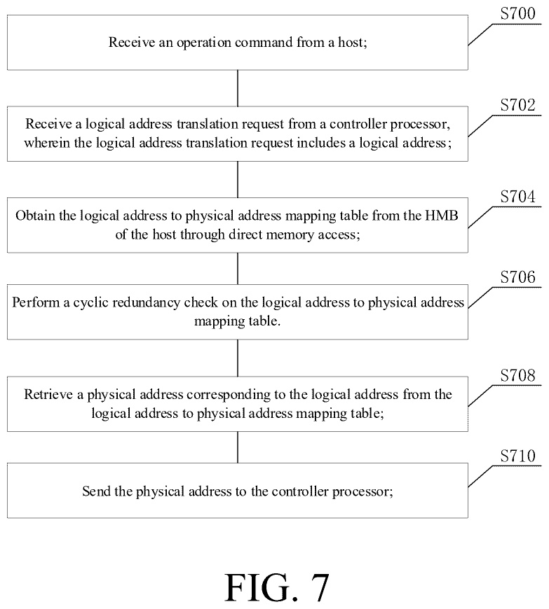

FIG. 7 shows a flowchart of an operation method of a memory system according to yet another example of the present disclosure. This example is applied to a host interface controller of a memory controller.

At S700, a host interface controller receives an operation command from a host. For example, the host interface controller receives a read operation command from the host, parses the read operation command, and places the parsed command into a command queue.

At S702, the host interface controller receives a logical address translation request from a controller processor, wherein the logical address translation request includes a logical address. The controller processor processes a command in the command queue, obtains a logical address in the command, and sends a logical address translation request to the host interface controller.

At S704, the host interface controller obtains the logical address to physical address mapping table and the CRC check information from the HMB of the host through direct memory access (DMA).

At S706, the host interface controller performs cyclic redundancy check on the logical address to physical address mapping table.

At S708, if the check passes, the host interface controller retrieves the logical address to physical address mapping table for a physical address corresponding to the logical address.

At S710, the host interface controller sends the obtained physical address to the controller processor for subsequent process.

In the foregoing example, the logical address to physical address mapping table and the CRC check information are obtained from the HMB of the host through the DMA, so that the process is fast and efficient. A CRC check is performed on the logical address to physical address mapping table, which ensures the security and integrity of process.

In an example, the logical address to physical address mapping table includes a plurality of sections. The host interface controller is configured to obtain one or more sections of the logical address to physical address mapping table from the host memory buffer.

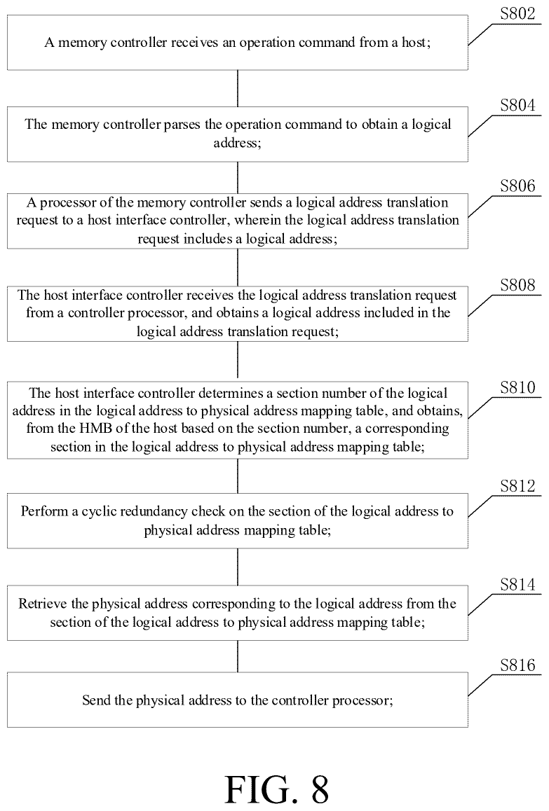

FIG. 8 shows a flowchart of an operation method of a memory system according to yet another example of the present disclosure. In this example, the L2P table is divided into a plurality of sections for respective storage, and each section generates corresponding CRC check information.

As shown in FIG. 8, at S802, a memory controller receives an operation command from a host.

At S804, the memory controller parses the operation command to obtain a logical address. The host interface controller parses the operation command, places the parsed operation command into a command queue of the memory controller, and the controller processor obtains a logical address from the operation command.

At S806, a controller processor sends a logical address translation request to a host interface controller, wherein the logical address translation request includes a logical address.

At S808, a host interface controller receives a logical address translation request from a controller processor, and obtains a logical address included in the logical address translation request.

At S810, the host interface controller determines a section number of the logical address in the logical address to physical address mapping table, and obtains, from the HMB of the host based on the section number, a corresponding section in the logical address to physical address mapping table.

At S812, the host interface controller performs cyclic redundancy check on the section of the logical address to physical address mapping table.

At S814, the host interface controller retrieves the section of the logical address to physical address mapping table for a physical address corresponding to the logical address.

At S816, the host interface controller sends the physical address to the controller processor.

In the foregoing example, since the logical address to physical address mapping table is stored in sections, when logical address to physical address address translation is performed, only a section corresponding to a logical address needs to be obtained, less data needs to be obtained, and a retrieve speed is faster; and corresponding CRC check is performed on each section, thereby ensuring process security and integrity.

In an example, the host interface controller of the memory controller maintains a section number management table for the L2P table, as shown in Table 1 below:

TABLE 1

| Section number | whether the section has been downloaded |
|---|---|
| 1 | N |
| 2 | Y |
| . . . | . . . |
| X | N |

The “section number” indicates a sequence number of a section, and “whether the section has been downloaded” indicates whether the section has been downloaded from the host HMB to the host interface controller, wherein N indicates that the section has not been downloaded, and Y indicates that the section has been downloaded. In an example, each section includes 4 kilobyte (KB) of data.

In an example, there is a limit to the number of L2P table sections that can be downloaded to the host interface controller at the same time, and when the number threshold is exceeded, the previously downloaded sections are replaced. For example, sections that are downloaded first may be replaced, or sections that are used less frequently may be replaced.

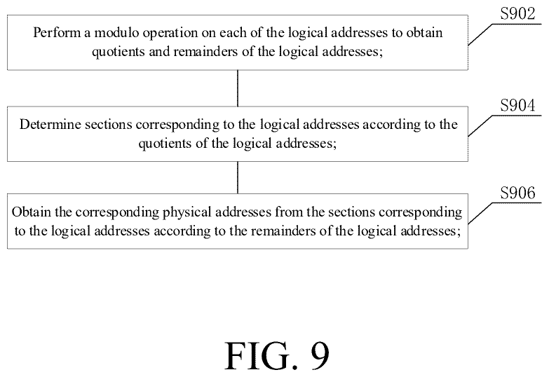

FIG. 9 shows a flowchart of obtaining a physical address corresponding to a logical address in an example of the present disclosure. This example is applied to a host interface controller.

As shown in FIG. 9, at S902, the host interface controller performs a modulo operation on each of the logical addresses to obtain a quotient and a remainder of the logical address.

At S904, the host interface controller determines, based on the quotient of the logical address, a section corresponding to the logical address.

At S906, the host interface controller obtains, based on the remainder of the logical address, a corresponding physical address from a section corresponding to the logical address.

In the foregoing example, the host interface controller performs the modulo operation on the logical address, determines the corresponding section according to the quotient, and obtains the corresponding physical address from the corresponding section based on the remainder, which has a fast process speed and high efficiency.

In an example, the modulo operation and the retrieve operation may be implemented by hardware, for example, a modulo operator, to achieve higher efficiency.

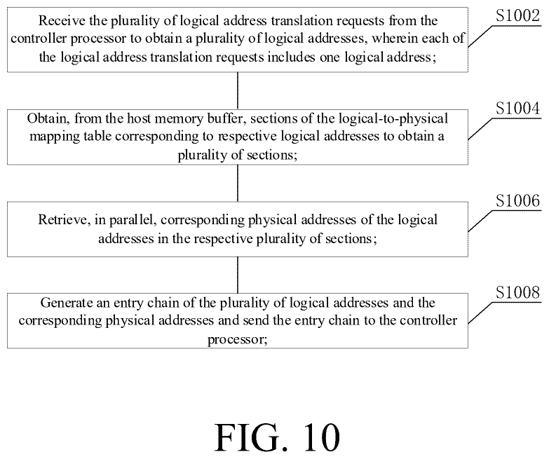

FIG. 10 shows a flowchart of an operation method of a memory system according to yet another example of the present disclosure. This example is applied to a host interface controller.

As shown in FIG. 10, at S1002, a host interface controller receives a plurality of logical address translation requests from a controller processor to obtain a plurality of logical addresses, wherein each logical address translation request includes one logical address.

At S1004, the host interface controller obtains, from the host memory buffer, sections of the logical address to physical address mapping table corresponding to various logical addresses, to obtain a plurality of sections.

At S1006, the host interface controller retrieves the plurality of sections in parallel for a corresponding physical address of a logical address.

At S1008, the host interface controller generates an entry chain of the plurality of logical addresses and the corresponding physical address and sends the entry chain to the controller processor.

In the foregoing example, the host interface controller receives a plurality of logical address translation requests, obtains a plurality of sections from the host memory buffer, retrieves the plurality of sections in parallel for a physical address corresponding to each logical address. The calculation process is changed from FW serial parsing to parallel parsing, thereby increasing an input/output operations per second (IOPS) of table lookup in a case of random read (RR). The operation may be implemented by hardware, and its process speed is faster.

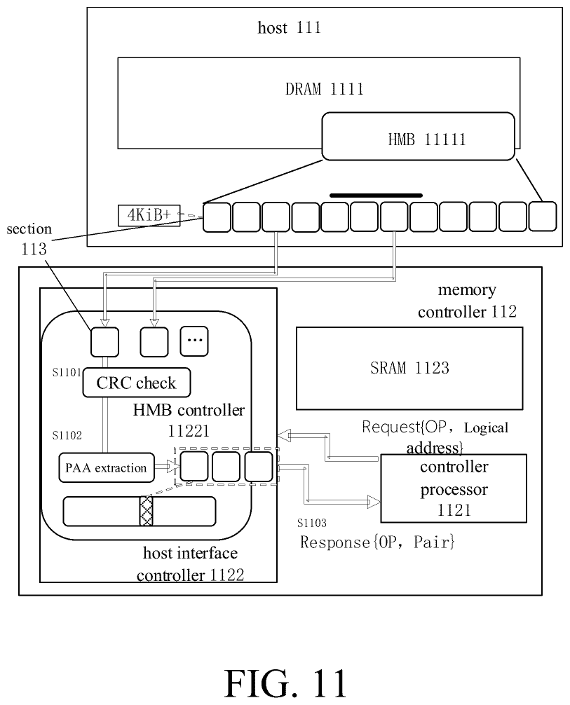

FIG. 11 illustrates a block diagram of an example system including a memory system according to an example of the present disclosure. As shown in FIG. 11, the system includes a host 111, the host includes a DRAM 1111, and the DRAM 1111 includes a partial storage space for an HMB 11111. The HMB 11111 stores sections 113 of a plurality of logical address to physical address mapping table, and each section 113 is, for example, defined as a 4 KiB entry space. The memory controller 112 is also included in the system. The memory controller 112 includes a controller processor 1121, a host interface controller 1122, and a SRAM 1123. The host interface controller 1122 includes an HMB controller 11221. The host interface controller 1122 receives an operation command from the host 111, parses the operation command, obtains key information of the operation command such as an operation code, a logical address, and a data length, and stores the key information in a command queue. The controller processor 1121 obtains a logical address in the command in response to receiving an operation command from the host, such as a read operation command. The controller processor 1121 sends a logical address translation request Request {OP, logical address} to the host interface controller 1122. The HMB controller 11221 obtains one or more sections of the logical address to physical address mapping tables from the HMB 11111 of the host in response to the logical address translation request, and performs CRC check (S1101). After the check passes, physical address (PAA) extraction is performed (S1102), and the obtained one or more pairs of logical address and physical address are returned to the controller processor 1121 (S1103) through Response {OP, Pair}.

In an example, there is also provided a computer-readable storage medium including instructions, such as a controller memory including instructions, which are executable by a controller processor of a memory controller to perform the above-described method. Optionally, the computer-readable storage medium may be a read only memory (ROM), a random access memory (RAM), a compact disc ROM (CD-ROM), a magnetic tape, a floppy disk, an optical data storage device, or the like.

In an example, a computer program product is further provided, including a computer program/instructions, wherein the computer program/instructions, when executed by a processor, implement the method in the foregoing examples.

It should be understood that “some examples” mentioned throughout the specification means that particular features, structures, or characteristics related to the examples are included in at least one example of the present disclosure. Therefore, “in some examples” or “in other examples” appearing throughout the specification does not necessarily refer to the same example. Furthermore, the particular features, structures, or characteristics may be combined in any suitable manner in one or more examples. It should be understood that, in various examples of the present disclosure, the sequence numbers of the above processes do not mean an execution order, and the execution order of each process should be determined by its function and internal logic, and should not constitute any limitation on the implementation process of the examples of the present disclosure. The sequence numbers of the above examples of the present disclosure are only for description, and do not represent the advantages or disadvantages of the examples.

It should be noted that, in this specification, the terms “include”, “comprise”, or any other variation thereof are intended to cover a non-exclusive inclusion, so that a process, a method, an article, or an device that includes a series of elements includes not only those elements, but also other elements that are not explicitly listed, or elements inherent to such a process, method, article, or device. Without further limitations, an element proceeded by “includes a . . . ” does not preclude the existence of additional identical elements in the process, method, article, or device that includes the element.

In the several examples provided in the present disclosure, it should be understood that the disclosed device and method may be implemented in other manners. The device examples described above are merely illustrative, for example, the division of the units is merely a logical function division, and there may be other division manners in actual implementation, for example, a plurality of units or components may be combined, or may be integrated into another system, or some features may be ignored or not performed. In addition, the coupling or direct coupling or communication connection between the displayed or discussed components may be indirect coupling or communication connection through some interfaces, devices or units, and may be electrical, mechanical or in other forms.

The units described as separate components may or may not be physically separate, and the components displayed as units may or may not be physical units; they may be located in one place or distributed on a plurality of network units; some or all of the units may be selected according to actual needs to achieve the objectives of the solutions of the examples.

In addition, the functional units in the examples of the present disclosure may all be integrated into one processing unit, or each unit may be separately used as one unit, or two or more units may be integrated into one unit; and the integrated unit may be implemented in a form of hardware, or may be implemented in a form of hardware plus a software functional unit.

Examples of the present disclosure provide a memory system, a memory controller, an operation method, a computer-readable storage medium, and a computer program product.

According to an aspect of the examples of the present disclosure, there is provided a memory system, including: a host including a memory, the memory storing a logical address to physical address mapping (L2P) table therein; and a memory controller coupled to the host, the memory controller including a host interface controller and a controller processor; wherein the host interface controller is configured to: receive an operation command from the host; receive a logical address translation request sent by the controller processor in response to the operation command, wherein the logical address translation request includes a logical address; retrieve a physical address (PAA) corresponding to the logical address from the logical address to physical address mapping table, wherein the logical address to physical address mapping table is obtained by the host interface controller from a memory of the host; and send the physical address to the controller processor.

In an example, the memory of the host includes a host memory buffer (HMB) storing the logical address to physical address mapping table (L2P) therein, and the host interface controller is further configured to: obtain the logical address to physical address mapping table from the host memory buffer through direct memory access (DMA).

In an example, the host interface controller is further configured to: perform a cyclic redundancy check (CRC) on the logical address to physical address mapping table in response to obtaining the logical address to physical address mapping table from the host memory buffer.

In an example, the logical address to physical address mapping table includes a plurality of sections, the host interface controller configured to: obtain one or more sections of the logical address to physical address mapping table from the host memory buffer.

In an example, the host interface controller is configured to: determine a section number of the logical address in the logical address to physical address mapping table; and obtain a corresponding section in the logical address to physical address mapping table from the host memory buffer according to the section number.

In an example, the logical address translation request includes a plurality of logical address translation requests, and the host interface controller is configured to: receive the plurality of logical address translation requests from the controller processor to obtain a plurality of logical addresses, wherein each of the logical address translation requests includes one logical address; obtain, from the host memory buffer, sections of the logical address to physical address mapping table corresponding to respective logical addresses to obtain a plurality of sections; retrieve, in parallel, corresponding physical addresses of the logical addresses in respective ones of the plurality of sections; and generate an entry chain of the plurality of logical addresses and the corresponding physical addresses and send the entry chain to the controller processor.

In an example, the host interface controller is configured to: perform a modulo operation on each of the logical addresses to obtain quotients and remainders of the logical addresses; determine sections corresponding to the logical addresses according to the quotients of the logical addresses; and obtain the corresponding physical addresses from the sections corresponding to the logical addresses according to the remainders of the logical addresses.

In an example, prior to receiving the logical address translation request from the controller processor, the host interface controller is further configured to: receive an operation command from the host; and parse the operation command, and place the parsed operation command into a command queue of the memory controller.

In an example, the host interface controller is further configured to: report a HMB characteristic and a required storage space size to the host after a system being powered on; and send the logical address to physical address mapping table obtained from a memory device to the host for the host to store the logical address to physical address mapping table in the host memory buffer.

According to another aspect of the present disclosure, there is provided a memory controller, including: a controller processor; and a host interface controller coupled to the controller processor and configured to execute control instructions to perform a process including: receiving an operation command from a host; receiving a logical address translation request sent by the controller processor in response to the operation command, wherein the logical address translation request includes a logical address; retrieving a physical address corresponding to the logical address from a logical address to physical address mapping table (L2P), wherein the logical address to physical address mapping table is obtained by the host interface controller from a memory of the host, and the memory of the host stores the logical address to physical address mapping table therein; and sending the physical address (PAA) to the controller processor.

In an example, the memory of the host includes a host memory buffer (HMB) which stores the logical address to physical address mapping table (L2P) therein, and the process further includes: obtaining the logical address to physical address mapping table from the host memory buffer through direct memory access (DMA).

In an example, the process further includes: performing a cyclic redundancy check (CRC) on the logical address to physical address mapping table in response to obtaining the logical address to physical address mapping table from the host memory buffer.

In an example, the logical address to physical address mapping table includes a plurality of sections, and the process includes: obtaining one or more sections of the logical address to physical address mapping table from the host memory buffer.

In an example, the process includes: determining a section number of the logical address in the logical address to physical address mapping table; and obtaining a corresponding section in the logical address to physical address mapping table from the host memory buffer according to the section number.

In an example, the logical address translation request includes a plurality of logical address translation requests, and the process includes: receiving the plurality of logical address translation requests from the controller processor to obtain a plurality of logical addresses, wherein each of the logical address translation requests includes one logical address; obtaining, from the host memory buffer, sections of the logical address to physical address mapping table corresponding to respective logical addresses to obtain a plurality of sections; retrieving, in parallel, corresponding physical addresses of the logical addresses in respective ones of the plurality of sections; and generating an entry chain of the plurality of logical addresses and the corresponding physical addresses and sending the entry chain to the controller processor.

In an example, the process includes: performing a modulo operation on each of the logical addresses to obtain quotients and remainders of the logical addresses; determining sections corresponding to the logical addresses according to the quotients of the logical addresses; and obtaining the corresponding physical addresses from the sections corresponding to the logical addresses according to the remainders of the logical addresses.

In an example, prior to receiving the logical address translation request from the controller processor, the process further includes: receiving an operation command from the host; and parsing the operation command, and placing the parsed operation command into a command queue of the memory controller.

In an example, the process further includes: reporting a HMB characteristic and a required storage space size to the host after a system being powered on; and sending the logical address to physical address mapping table obtained from a memory device to the host for the host to store the logical address to physical address mapping table in the host memory buffer.

According to another aspect of the present disclosure, there is provided an operation method of a memory system, wherein the operation method is applied to a host interface controller and includes: receiving an operation command from the host; receiving a logical address translation request sent by the controller processor in response to the operation command, wherein the logical address translation request includes a logical address; retrieving a physical address corresponding to the logical address from a logical address to physical address mapping table (L2P), wherein the logical address to physical address mapping table is obtained by the host interface controller from a memory of the host, and the memory of the host stores the logical address to physical address mapping table therein; and sending the physical address (PAA) to the controller processor.

In an example, the memory of the host includes a host memory buffer (HMB) storing a logical address to physical address mapping table (L2P) therein, and the operation method further includes: obtaining the logical address to physical address mapping table from the host memory buffer through direct memory access (DMA).

In an example, the method further includes performing a cyclic redundancy check (CRC) on the logical address to physical address mapping table in response to obtaining the logical address to physical address mapping table from the host memory buffer.

In an example, the logical address to physical address mapping table includes a plurality of sections, and the obtaining the logical address to physical address mapping table from the HMB of the host through the direct memory access (DMA), includes: obtaining one or more sections of the logical address to physical address mapping table from the host memory buffer through the DMA.

In an example, the obtaining one or more sections of the logical address to physical address mapping table from the HMB of the host, includes: determining a section number of the logical address in the logical address to physical address mapping table; and obtaining a corresponding section in the logical address to physical address mapping table from the host memory buffer according to the section number.

In an example, the logical address translation request includes a plurality of logical address translation requests, wherein the obtaining one or more sections of the logical address to physical address mapping table from the HMB of the host, includes: receiving the plurality of logical address translation requests from the controller processor to obtain a plurality of logical addresses, wherein each of the logical address translation requests includes one logical address; obtaining, from the host memory buffer, sections of the logical address to physical address mapping table corresponding to respective logical addresses to obtain a plurality of sections; wherein the retrieving a physical address corresponding to the logical address from a logical address to physical address mapping table, includes: retrieving, in parallel, corresponding physical addresses of the logical addresses in respective ones of the plurality of sections; and wherein the sending the physical address to the controller processor, includes: generating an entry chain of the plurality of logical addresses and the corresponding physical addresses and sending the entry chain to the controller processor.

In an example, the retrieving, in parallel, corresponding physical addresses of the logical addresses in respective ones of the plurality of sections, includes: performing a modulo operation on each of the logical addresses to obtain quotients and remainders of the logical addresses; determining sections corresponding to the logical addresses according to the quotients of the logical addresses; and obtaining the corresponding physical addresses from the sections corresponding to the logical addresses according to the remainders of the logical addresses.

In an example, prior to receiving the logical address translation request from the controller processor, the method further includes: receiving an operation command from the host; and parsing the operation command, and placing the parsed operation command into a command queue of the memory controller.

In an example, the method further includes: reporting a HMB characteristic and a required storage space size to the host after a system being powered on; and sending the logical address to physical address mapping table obtained from a memory device to the host for the host to store the logical address to physical address mapping table in the host memory buffer.

According to another aspect of the present disclosure, there is provided a computer-readable storage medium, wherein when a control instruction in the computer-readable storage medium is executed by a controller processor, the controller processor is enabled to perform an operation method of a memory system, wherein the operation method is applied to a host interface controller and includes: receiving an operation command from the host; receiving a logical address translation request sent by the controller processor in response to the operation command, wherein the logical address translation request includes a logical address; retrieving a physical address corresponding to the logical address from a logical address to physical address mapping table, wherein the logical address to physical address mapping table is obtained by the host interface controller from a memory of the host, and the memory of the host stores the logical address to physical address mapping table therein; and sending the physical address to the controller processor.

According to another aspect of the present disclosure, there is provided a computer program product including computer programs/instructions, wherein when being executed by a processor, the computer programs/instructions implement an operation method of a memory system, wherein the operation method is applied to a host interface controller and includes: receiving an operation command from a host; receiving a logical address translation request sent by the controller processor in response to the operation command, wherein the logical address translation request includes a logical address; retrieving a physical address corresponding to the logical address from a logical address to physical address mapping table, wherein the logical address to physical address mapping table is obtained by the host interface controller from a memory of the host, and the memory of the host stores the logical address to physical address mapping table therein; and sending the physical address to the controller processor.

In the memory system, the memory controller, the operation method, the computer-readable storage medium, and the computer program product in the examples of the present disclosure, in response to the operation command from the host, the host interface controller obtains the logical address to physical address mapping table from the host memory, and the host interface controller directly retrieves the physical address corresponding to the logical address based on the logical address translation request sent by the controller processor, thereby reducing migration of the logical address to physical address mapping table in the memory system, improving performance, and reducing energy consumption.

It is to be understood that the foregoing general description and the following detailed description are examples and explanatory only and are not to limit the present disclosure.

The above is only specific examples of the present disclosure, but the protection scope of the present disclosure is not limited thereto. Any person skilled in the art can readily appreciate that changes or substitutions may be made within the technical scope disclosed in the present disclosure, which should be included in the protection scope of the present disclosure. Therefore, the protection scope of the present disclosure should be based on the protection scope of the claims.

What is claimed is:

1. A memory system, including:
a host including a memory, the memory storing a logical address to physical address mapping (L2P) table; and
a memory controller coupled to the host, the memory controller including a host interface controller and a controller processor;
wherein the host interface controller is configured to:
receive an operation command from the host;
receive a logical address translation request sent by the controller processor in response to the operation command, wherein the logical address translation request includes a logical address;
retrieve a physical address corresponding to the logical address from the logical address to physical address mapping table, wherein the logical address to physical address mapping table is obtained by the host interface controller from the memory of the host; and
send the physical address to the controller processor.

2. The memory system of claim 1, wherein the memory of the host includes a host memory buffer (HMB) storing the logical address to physical address mapping table therein, and the host interface controller is further configured to:
obtain the logical address to physical address mapping table from the host memory buffer through direct memory access.

3. The memory system of claim 2, wherein the host interface controller is further configured to:
perform a cyclic redundancy check on the logical address to physical address mapping table in response to obtaining the logical address to physical address mapping table from the host memory buffer.

4. The memory system of claim 2, wherein the logical address to physical address mapping table includes a plurality of sections, the host interface controller configured to:
obtain one or more sections of the logical address to physical address mapping table from the host memory buffer.

5. The memory system of claim 4, wherein the host interface controller is configured to:
determine a section number of the logical address in the logical address to physical address mapping table; and
obtain a corresponding section in the logical address to physical address mapping table from the host memory buffer according to the section number.

6. The memory system of claim 4, wherein the logical address translation request includes a plurality of logical address translation requests, and the host interface controller is configured to:
receive the plurality of logical address translation requests from the controller processor to obtain a plurality of logical addresses, wherein each of the logical address translation requests includes one logical address;
obtain, from the host memory buffer, sections of the logical address to physical address mapping table corresponding to respective logical addresses to obtain the plurality of sections;
retrieve, in parallel, corresponding physical addresses of the logical addresses in respective ones of the plurality of sections; and
generate an entry chain of the plurality of logical addresses and the corresponding physical addresses and send the entry chain to the controller processor.

7. The memory system of claim 6, wherein the host interface controller is configured to:
perform a modulo operation on each of the logical addresses to obtain quotients and remainders of the logical addresses;
determine the sections corresponding to the logical addresses according to the quotients of the logical addresses; and
obtain the corresponding physical addresses from the sections corresponding to the logical addresses according to the remainders of the logical addresses.

8. The memory system of claim 1, wherein prior to receiving the logical address translation request from the controller processor, the host interface controller is further configured to:
parse the operation command; and
place the parsed operation command into a command queue of the memory controller.

9. The memory system of claim 2, wherein the host interface controller is further configured to:
report a HMB characteristic and a required storage space size to the host after a system being powered on; and
send the logical address to physical address mapping table obtained from a memory device to the host, the host to store the logical address to physical address mapping table in the host memory buffer.

10. A memory controller, including:
a controller processor; and
a host interface controller coupled to the controller processor and configured to execute control instructions, the control instructions to cause the host interface controller to:
receive an operation command from a host;
receive a logical address translation request sent by the controller processor in response to the operation command, wherein the logical address translation request includes a logical address;
retrieve a physical address corresponding to the logical address from a logical address to physical address mapping table, wherein the logical address to physical address mapping table is obtained by the host interface controller from a memory of the host, and the memory of the host stores the logical address to physical address mapping table; and
send the physical address to the controller processor.

11. The memory controller according to claim 10, wherein the memory of the host includes a host memory buffer (HMB) storing the logical address to physical address mapping table, and the host interface controller to:
obtain the logical address to physical address mapping table from the host memory buffer through direct memory access.

12. A method of a memory system, the method comprising:
receiving an operation command from a host;
receiving a logical address translation request sent by a controller processor in response to the operation command, wherein the logical address translation request includes a logical address;
retrieving a physical address corresponding to the logical address from a logical address to physical address mapping table, wherein the logical address to physical address mapping table is obtained by a host interface controller from a memory of the host, and the memory of the host stores the logical address to physical address mapping table; and
sending the physical address to the controller processor.

13. The method according to claim 12, wherein the memory of the host includes a host memory buffer (HMB) storing a logical address to physical address mapping table, and the method further includes:
obtaining the logical address to physical address mapping table from the host memory buffer through direct memory access (DMA).

14. The method according to claim 13, further including:
performing a cyclic redundancy check on the logical address to physical address mapping table in response to obtaining the logical address to physical address mapping table from the host memory buffer.

15. The method according to claim 13, wherein the logical address to physical address mapping table includes a plurality of sections, and the obtaining the logical address to physical address mapping table from the HMB of the host through the DMA, includes:
obtaining one or more sections of the logical address to physical address mapping table from the host memory buffer through the DMA.

16. The method according to claim 15, wherein the obtaining of the one or more sections of the logical address to physical address mapping table from the HMB of the host includes:
determining a section number of the logical address in the logical address to physical address mapping table; and
obtaining a corresponding section in the logical address to physical address mapping table from the host memory buffer according to the section number.

17. The method according to claim 15, wherein the logical address translation request includes a plurality of logical address translation requests,
wherein the obtaining of the one or more sections of the logical address to physical address mapping table from the HMB of the host includes:
receiving the plurality of logical address translation requests from the controller processor to obtain a plurality of logical addresses, wherein each of the logical address translation requests includes one logical address; and
obtaining, from the host memory buffer, sections of the logical address to physical address mapping table corresponding to respective logical addresses to obtain the plurality of sections;
wherein the retrieving of the physical address corresponding to the logical address from the logical address to physical address mapping table includes:
retrieving, in parallel, corresponding physical addresses of the logical addresses in respective ones of the plurality of sections; and
wherein the sending of the physical address to the controller processor includes:
generating an entry chain of the plurality of logical addresses and the corresponding physical addresses; and
sending the entry chain to the controller processor.

18. The method according to claim 17, wherein the retrieving, in parallel, of the corresponding physical addresses of the logical addresses in respective ones of the plurality of sections includes:
performing a modulo operation on each of the logical addresses to obtain quotients and remainders of the logical addresses;
determining the sections corresponding to the logical addresses according to the quotients of the logical addresses; and
obtaining the corresponding physical addresses from the sections corresponding to the logical addresses according to the remainders of the logical addresses.

19. The method according to claim 13, wherein prior to receiving the logical address translation request from the controller processor, the method further includes:
parsing the operation command; and
placing the parsed operation command into a command queue of a memory controller.

20. The method according to claim 12, further including:
reporting a host memory buffer characteristic and a required storage space size to the host after a system is powered on; and
sending the logical address to physical address mapping table obtained to the host, the host to store the logical address to physical address mapping table in a host memory buffer.
